(19) United States
(12) Patent Application Publication
(10) Pub. No.: US 2026/0282186 A1
(43) Pub. Date: Sep. 17, 2026

(54) METHOD OF OPERATING AN OPTOELECTRONIC COMPONENT, METHOD OF MANUFACTURING AN OPTOELECTRONIC COMPONENT, OPTOELECTRONIC COMPONENT, AND ILLUMINATION DEVICE

(71) Applicant: ams-OSRAM International GmbH, Regensburg (DE)

(72) Inventors: Stefan GROETSCH, Bad Abbach (DE); Rainer HUBER, Bad Abbach (DE); Bilal SAIF, Regensburg (DE); Markus KOESLER, Landshut (DE); Igor STANKE, Regensburg (DE); Joachim REILL, Regenstauf (DE); Christian ZIEREIS, Regensburg (DE)

(21) Appl. No.: 19/472,045

(22) PCT Filed: Apr. 4, 2024
(86) PCT No.: PCT/EP2024/059244

§ 371 Date: Oct. 2, 2025

(30) Foreign Application Priority Data
Apr. 6, 2023 (DE) 10 2023 108 932.3

(51) Int. Cl. H05B 45/18; H05B 45/56

(52) U.S. Cl. CPC H05B 45/18; H05B 45/56

(57) ABSTRACT

The invention relates an optoelectronic-component having a pixel array with a plurality of optoelectronic semiconductor emitters/chips, a temperature sensor, and a driving circuit. A temperature is read out, using the sensor. An operation parameter of the pixel array is determined. Based on the operation parameter and a model of the pixel array, a temperature difference between the temperature read-out from the temperature sensor and a junction temperature of the pixel array is established. The temperature difference is different for at least two values of the operation parameter. The temperature of the temperature sensor is added to the temperature difference. The sum of the temperature of the temperature sensor and the temperature difference is compared to a maximum junction temperature. A power of the pixel array is reduced when the sum of the temperature of the temperature sensor and the temperature difference exceeds the maximum junction temperature.

### DESCRIPTION

The present invention relates to a method of operating an optoelectronic component, a method of manufacturing an optoelectronic component, an optoelectronic component, and an illumination device.

This patent application claims the priority of German patent application 10 2023 108 932.3, the disclosure content of which is hereby incorporated by reference.

Optoelectronic components with pixel arrays and a driving circuit for the pixel array are known in the state of the art. Pixel arrays comprise an at least two-dimensional arrangement of optoelectronic semiconductor emitters or even chips. In operation, these pixels may be driven individually, particularly allowing for an image projected by the pixel array. These pixel arrays may, for example, be used in automotive headlamps or active pixel projectors.

These optoelectronic components usually include a temperature sensor to monitor an operating temperature of the pixels of the pixel array. At a given maximum temperature partial damage of the pixel array could occur and therefore the power of the pixel array may be reduced when the temperature measured by the temperature sensor exceeds a certain value, which may be called shut-off temperature. However, due to thermal conductivity and the fact that heat is produced directly at pn-junctions of the pixels and needs to reach the temperature sensor, the shut-off temperature is smaller than the maximum temperature to allow for thermal equilibrium. For some operating parameters of the pixel array this might result in a decrease of power although the maximum temperature of the pn-junctions is not reached yet.

An objective of the present invention is to provide an improved method of operating an optoelectronic component. Another objective of the present invention is to provide an improved method of manufacturing an optoelectronic component. Further objectives are to provide an improved optoelectronic component and an illumination device with such an optoelectronic component. These objectives are resolved with the method of operating an optoelectronic component, the method of manufacturing an optoelectronic component, the optoelectronic component, and the illumination device of the independent claims. Dependent claims specify advantageous embodiments.

According to a first aspect, the invention relates to a method of operating an optoelectronic component. The optoelectronic component at least comprises a pixel array with a plurality of optoelectronic semiconductor emitters or chips, a temperature sensor, and a driving circuit. Particularly, the pixel array may include a great number pixels and therefore optoelectronic semiconductor chips or a large optoelectronic pixel array chip. The number of pixels may be around 16.000 to 26.000 or even greater, particularly around 50.000 or even 100.000. Furthermore, the optoelectronic component may include other elements like a housing and/or a power supply. The temperature sensor is in thermal contact with the pixel array. To operate the optoelectronic component the steps explained in the following are executed. A temperature is read out, using the temperature sensor. Additionally, an operation parameter of the pixel array is determined. These two steps may be executed simultaneously or in any order. Based on the operation parameter and a model of the pixel array, a temperature difference between the temperature read-out from the temperature sensor and a junction temperature of a pn-junction of the pixel array is established. Thereby, the temperature difference is different for at least two values of the operation parameter. Then, the temperature of the temperature sensor is added to the temperature difference. The sum of the temperature of the temperature sensor and the temperature difference is compared to a maximum junction temperature. The power of the pixel array is reduced when the sum of the temperature of the temperature sensor and the temperature difference exceeds the maximum junction temperature. Therefore, a damage of the pixel array may be reduced or prevented. However, as the temperature difference is different for at least two values of the operation parameter, it is possible to allow for an operation of the optoelectronic component closer to the maximum junction temperature and therefore, less decrease of power of the optoelectronic component may be achieved.

The model of the pixel array may include which temperatures of the pn-junctions may be reached dependent on different operating parameters. This allows for a more granular approach compared to the state of the art, as for different operating parameters different temperature differences may be used according to the model and therefore, for at least some of the operating parameters, the reduction of power of the pixel array may be delayed compared to the optoelectronic components known from the prior art.

According to a second aspect, the invention relates to an optoelectronic component. The optoelectronic component at least comprises a pixel array with a plurality of optoelectronic semiconductor emitters or chips, a temperature sensor, and a driving circuit. Particularly, the pixel array may include a great number pixels and therefore optoelectronic semiconductor emitters or chips or a multiemitter chip. The number of pixels may be around 16.000 to 26.000 or even greater, particularly around 50.000 or even 100.000. Furthermore, the optoelectronic component may include other elements like a housing and/or a power supply. The temperature sensor is in thermal contact with the pixel array. The driving circuit is equipped to execute the method of operation as explained above. The driving circuit may comprise a central processing unit to execute the method steps. Additionally, the driving circuit may include a control for individually controlling the pixels of the pixel array, particularly by controlling voltage, current or power of the pixels individually.

According to a third aspect, the invention relates to an illumination device with such an optoelectronic component. The illumination device may particularly be suited to work as an automotive headlamp or as an active pixel projector.

According to a fourth aspect, the invention relates to a method of manufacturing an optoelectronic component. In this method, the pixel array, the driving circuit and the temperature sensor are provided in such a way that the temperature sensor is in thermal contact with the pixel array. Additionally, the model of the pixel array is established, regarding a relationship between the operation parameter and the temperature difference. This model is then provided for the driving circuit.

In one embodiment of the method of operating the model of the pixel array is stored in a memory of the driving circuit and may be read-out from that memory. In an embodiment of the optoelectronic component, the driving circuit includes the memory. The memory may be a read-only memory.

In one embodiment of the method of operating the operation parameter includes a current drawn by the pixel array. This current may be a sum of all currents for all individual pixels at a time. The sum of all currents for all individual pixels may be used as a parameter of an overall power of the pixel array and therefore provides a measure of the overall heat expected to be created at the pn-junctions. The temperature difference may then be set accordingly.

In one embodiment of the method of operating the operation parameter includes a voltage supplied to the pixel array. The voltage may be a mean value of the voltages provided for the individual pixels. The mean value of the voltages corresponds to a mean value of the power of the pixel array and therefore provides a measure of the overall heat expected to be created at the pn-junctions. The temperature difference may then be set accordingly.

In one embodiment of the method of operating the operation parameter includes a power supplied to the pixel array. The power directly corresponds to the overall heat expected to be created at the pn-junctions. The temperature difference may then be set accordingly.

In one embodiment of the method of operating the operation parameter includes an image to be displayed by the pixel array. Dependent on the image, a heat expected to be created at the pn-junctions can be estimated and therefore the temperature difference may then be set accordingly.

In one embodiment of the method of operating a brightness value of the pixels of the pixel array is added up and used as operation parameter. The added-up brightness value of the pixels is also a good measure for a heat expected to be created at the pn-junctions and therefore the temperature difference may then be set accordingly.

In one embodiment of the method of operating the model includes a lookup table for a correlation between operation parameter and temperature difference. A lookup table allows for an efficient way to use a model for a relationship between an operating parameter and a temperature difference, as it may significantly save processing time.

In one embodiment of the method of operating the model includes a regression of a relation of values of temperature differences and values of the operation parameter. This allows for a more exact approach with overall increased pixel array power as a minimum decrease of power of the optoelectronic component may be achieved with such regression.

In one embodiment of the method of operating the power of the pixel array is reduced by means of a pulse-width-modulation or a reduction of driving current and/or driving voltage of the pixel array. These methods allow for an easy to achieve reduction of the power of the pixel array.

In one embodiment of the optoelectronic component the optoelectronic component further comprises a projection objective. The projection objective may include a number of projection lenses, particularly up to ten lenses, and may be used to project an image provided by the pixel array to a greater area.

In one embodiment of the method of manufacturing the model is determined theoretically. This may allow for an easy determination of the model, which may be done once and the obtained model may be used for several optoelectronic components.

In one embodiment of the method of manufacturing the model is determined experimentally. This may allow for a more precise approach. Particularly, temperature differences of the pn-junctions compared to the temperature measured by the temperature sensor may be measured, for instance by an infrared temperature measurement, and related to operation parameters of the pixel array. This may be executed for several pixel arrays and a mean value for the temperature difference may be obtained and then be used for the model. In an alternative approach, these measurements may be performed for each optoelectronic component individually and a unique model describing the relationship between temperature difference and operating parameter may be obtained for each optoelectronic component.

The terminus temperature difference is to be understood as the lowest temperature difference from optoelectronic PN to sensor temperature to be considered for the power derating.

It therefore represents the worst-case temperature difference expected for the correlating operating parameter.

The properties, features and advantages of the present invention described above, as well as the way they are achieved, become clearer and more understandable in connection with the following description of the embodiment examples, which are explained in more detail in connection with the drawings. In each case, the following examples show in a schematic representation

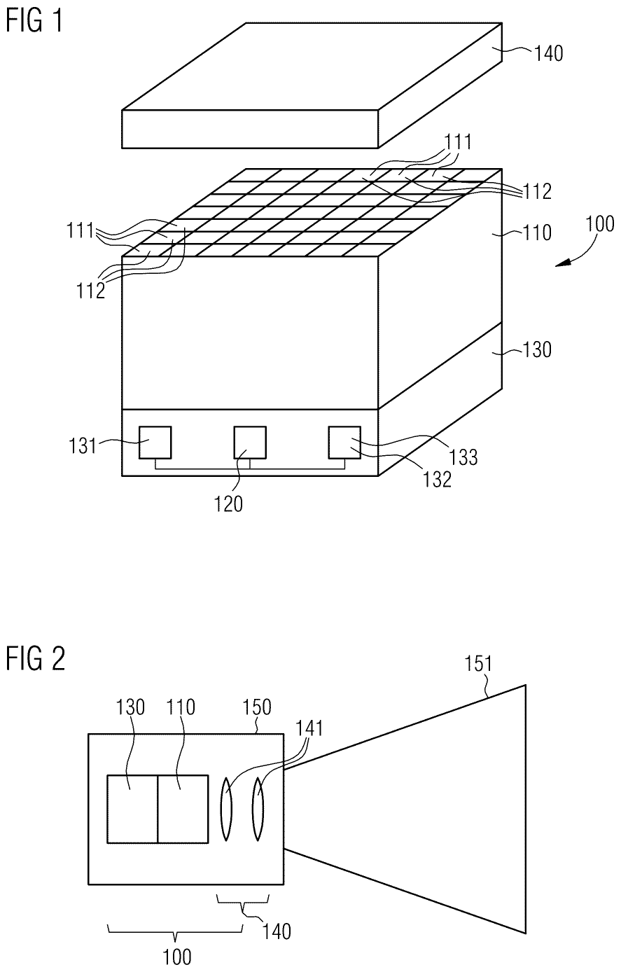

FIG. 1 an optoelectronic component;

FIG. 2 an illumination device;

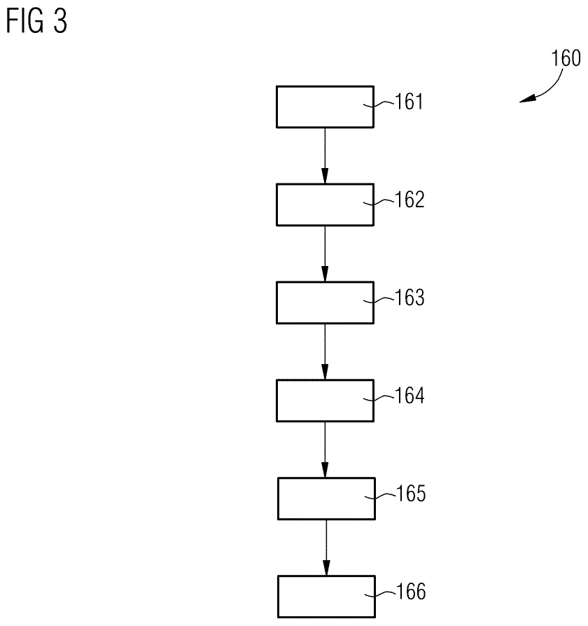

FIG. 3 a flowchart of a method of operating an optoelectronic component;

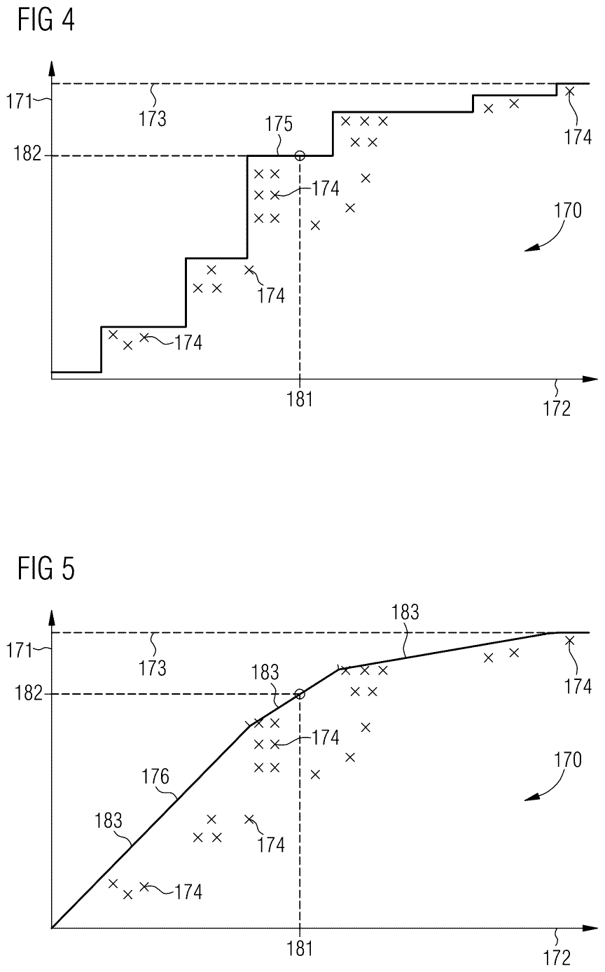

FIG. 4 a first model for a method of operating an optoelectronic component;

FIG. 5 a second model for a method of operating an optoelectronic component;

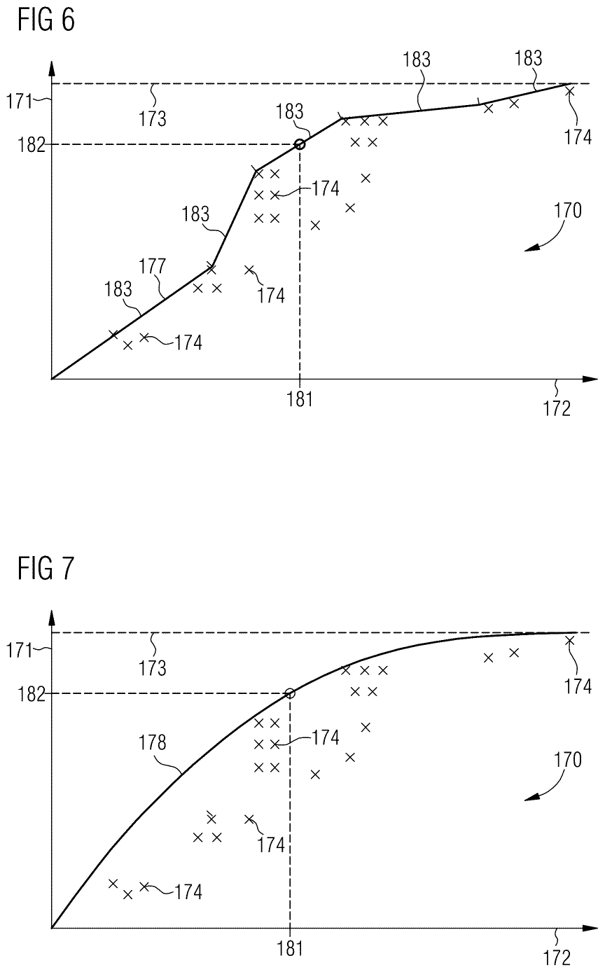

FIG. 6 a third model for a method of operating an optoelectronic component;

FIG. 7 a fourth model for a method of operating an optoelectronic component; and

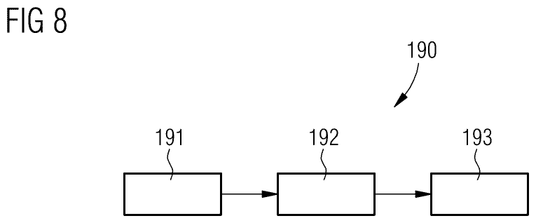

FIG. 8 a flowchart of a method of manufacturing an optoelectronic component.

FIG. 1 shows an optoelectronic component 100 comprising a pixel array 110 with a plurality of optoelectronic semiconductor emitters or chips 111, a temperature sensor 120, and a driving circuit 130. The temperature sensor 120 is in thermal contact with the pixel array 110. The driving circuit 130 is equipped to execute a method of operating the optoelectronic component which will be explained in further detail below.

Particularly, the pixel array 110 may include a great number pixels 112 and therefore optoelectronic semiconductor emitters/chips 111. For sake of clarity, not all pixels have the reference sign 112 and not all optoelectronic semiconductor emitters/chips have the reference sign 111. The number of pixels 112 is 28 in FIG. 1, but may be around 16.000 to 26.000 or even greater, particularly around 50.000 or even 100.000 for an optoelectronic component 100. Furthermore, the optoelectronic component 100 may include other elements like a housing and/or a power supply, which are not shown in FIG. 1, but may be provided by a person of artisan skill. The temperature sensor 120 is shown to be a part of the driving circuit. However, in an embodiment not shown the temperature sensor 120 may be arranged in between the pixel array 110 and the driving circuit 130 or at the side of the pixel array 130. The driving circuit 130 may comprise a central processing unit 131 to execute method steps to operate the optoelectronic component 100. Additionally, the driving circuit 130 may include a control for individually controlling the pixels 112 of the pixel array 110, particularly by controlling voltage, current or power of the pixels individually. This control may also be included into the processing unit 131.

The optoelectronic component 100 further comprises an optional projection objective 140. The projection objective 140 may include a number of projection lenses, particularly up to ten lenses, and may be used to project an image provided by the pixel array 110 to a greater area.

The pixel array 110 comprises an at least two-dimensional arrangement of optoelectronic semiconductor emitters/chips 111. In operation, the pixels 112 may be driven individually, particularly allowing for an image projected by the pixel array 110. The optoelectronic component 100 with the pixel array 110 may, for example, be used in automotive headlamps or active pixel projectors. The pixels 112 can have a uniform emission spectrum, particularly emitting white light. However, it is also possible that a number of pixels 112, particularly three are combined and form an RGB-emitting unit.

FIG. 2 shows an illumination device 150. The illumination device 150 comprises the optoelectronic component 100 of FIG. 1. In this embodiment, the projection objective 140 is depicted as two projection lenses 141. Additionally, a light cone 151 emitted from the illumination device 150 is shown in FIG. 2.

FIG. 3 shows a flowchart 160 of a method of operating the optoelectronic component 100 if FIG. 1. In a first step 161, a temperature is read out, using the temperature sensor 120. This may be performed by measuring a parameter of the temperature sensor 120, particularly a parameter dependent on temperature. The temperature sensor 120 may output the temperature as an analog value or as a digital value. Additionally, an operation parameter of the pixel array 110 is determined in a second step 162. These two steps 161, 162 may be executed simultaneously or in any order. In a third step 163, a temperature difference between the temperature read-out from the temperature sensor 120 and a junction temperature of a pn-junction of the pixel array 110 is established based on the operation parameter and a model of the pixel array 110. Thereby, the temperature difference is different for at least two values of the operation parameter. In a subsequent fourth step 164, the temperature of the temperature sensor 120 is added to the temperature difference. In a fifth step 165, the sum of the temperature of the temperature sensor 120 and the temperature difference is compared to a maximum junction temperature. In a sixth step, a power of the pixel array 110 is reduced when the sum of the temperature of the temperature sensor and the temperature difference exceeds the maximum junction temperature. Therefore, a damage of the pixel array 110 may be reduced or prevented. However, as the temperature difference is different for at least two values of the operation parameter, it is possible to allow for an operation of the optoelectronic component 100 closer to the maximum junction temperature and therefore, less decrease of power of the optoelectronic component 100 may be achieved. The maximum junction temperature may be related to a temperature at which physical damage of the pn-junction is expected or might occur.

The method steps 161, 162, 163, 164, 165, 166 may be executed by the driving circuit 130 and particularly by the central processing unit 131. Particularly the third method step 163 is defining the method according to the invention. In methods of operating optoelectronic components 100 known in the state of the art, only one temperature difference is applied to allow for an estimation of thermal flow between the pn-junction of the pixels 112 and the temperature sensor 120. In the method according to the invention, different temperature differences are used dependent on the operation parameter and therefore, a more exact approach is possible. The model of the pixel array 110 may include which temperatures of the pn-junctions may be reached dependent on different operating parameters. This allows for a more granular approach compared to the state of the art, as for different operating parameters different temperature differences may be used according to the model and therefore, for at least some of the operating parameters, the reduction of power of the pixel array 110 may be delayed compared to the optoelectronic components known from the prior art.

In one embodiment of the method of operating the model of the pixel array 110 is stored in the memory 132 of the driving circuit 130. The model may be read-out from that memory 132. In an embodiment of the optoelectronic component 100, the driving circuit 130 includes the memory 132 as shown in FIG. 1. The memory 132 may be a read-only memory 133. Alternatively, the driving circuit 130 may be equipped to read the model from an external memory, wherein the external memory is located in an external device.

In one embodiment of the method of operating the operation parameter includes a current supplied to the pixel array 110. This current may be a sum of all currents for all individual pixels 112. The sum of all currents for all individual pixels 112 may be used as a parameter of an overall power of the pixel array 110 and therefore provides a measure of the overall heat expected to be created at the pn-junctions. The temperature difference may then be set accordingly. Alternatively, a mean value of the currents may also be used.

In one embodiment of the method of operating the operation parameter includes a voltage supplied to the pixel array 110. The voltage may be a mean value of the voltages provided for the individual pixels 112. The mean value of the voltages corresponds to a mean value of the power of the pixel array and therefore provides a measure of the overall heat expected to be created at the pn-junctions. The temperature difference may then be set accordingly. Alternatively, a sum of the voltages may also be used.

In one embodiment of the method of operating the operation parameter includes a power supplied to the pixel array 110.

The power directly corresponds to the overall heat expected to be created at the pn-junctions. The temperature difference may then be set accordingly.

In one embodiment of the method of operating the operation parameter includes an image to be displayed by the pixel array 110. Dependent on the image, a heat expected to be created at the pn-junctions can be estimated and therefore the temperature difference may then be set accordingly.

In one embodiment of the method of operating a brightness value of the pixels 112 of the pixel array 110 is added up and used as operation parameter. The added-up brightness value of the pixels is also a good measure for a heat expected to be created at the pn-junctions and therefore the temperature difference may then be set accordingly.

In one embodiment of the method of operating the power of the pixel array 110 is reduced by means of a pulse-width-modulation or a reduction of driving current and/or driving voltage of the pixel array 110. These methods allow for an easy to achieve reduction of the power of the pixel array 110.

FIGS. 4 to 7 show different embodiments related to different models that may be used in the third step 163. Each of these Figs. shows a diagram 170 of temperature differences 171 over operating parameters 172. A dashed line 173 indicates the temperature difference used in the state of the art. Each of the crosses 174 indicates one temperature difference for a given value of the operation parameter determined with a known or expected use case/image. However, also note that not all crosses 174 are indicated with a reference sign for sake of clarity. The diagrams 170 clearly indicate that operating parameters 172 exist, for which reducing power at temperatures given by the dashed line 173 leads to an inefficient operation, as the temperature difference for the most range of the operating parameters 172 would allow for a further temperature increase.

The temperature difference for a given value of the operation parameter may be obtained theoretically or experimentally. Determining the model theoretically may allow for an easy determination of the model, which may be done once and the obtained model may be used for several optoelectronic components 100. Determining the model experimentally may allow for a more precise approach. Particularly, temperature differences of the pn-junctions compared to the temperature measured by the temperature sensor 120 may be measured, for instance by an infrared temperature measurement, and related to operation parameters of the pixel array 110. This may be executed for several pixel arrays 110 and a mean value for the temperature difference may be obtained and then be used for the model. In an alternative approach, these measurements may be performed for each optoelectronic component 100 individually and a unique model describing the relationship between temperature difference and operating parameter may be obtained for each optoelectronic component 100. The diagrams 170 of FIGS. 4 to 7 may therefore be obtained theoretically or experimentally. However, both approaches might lead to the diagrams as shown in FIGS. 4 to 7. Dependent on the image with which the pixel array 110 is operated, similar operation parameters may lead to different temperature differences. For example, the temperature difference is higher when all pixels 112 are driven with half power compared to half of the pixels 112 with full power. The worst-case scenario is then selected as temperature difference.

FIG. 4 furthermore shows a first model 175 for a relationship of temperature differences 171 over operating parameters 172. The first model 175 uses a lookup table. With the lookup table, a relationship between temperature difference and operating parameter may be described by a step function. Each cross 174 is located below the step function. During operation, the operating parameter may be determined to be a current operating parameter 181. According to the current operating parameter 181, a corresponding temperature difference 182 may be selected, using the first model 175. The corresponding temperature difference 182 is below the temperature indicated by the dashed line 173. Therefore, the method allows to add the corresponding temperature difference 182 to the temperature measured by the temperature sensor 120, resulting in a lower temperature compared to a temperature calculated by adding the temperature measured by the temperature sensor 120 to the temperature indicated by the dashed line 173. Thusly, the reduction of operation power may be delayed, as a further temperature reserve exists for this current operating parameter 182.

FIG. 5 furthermore shows a second model 176 for a relationship of temperature differences 171 over operating parameters 172. The second model 176 includes a regression of a relation of values of temperature differences and values of the operation parameter. The second model 176 particularly includes three line segments 183 with a uniform slope for each line segment 183. According to the current operating parameter 181, a corresponding temperature difference 182 may be selected, using the second model 176. The corresponding temperature difference 182 is below the temperature indicated by the dashed line 173. Therefore, the method allows to add the corresponding temperature difference 182 to the temperature measured by the temperature sensor 120, resulting in a lower temperature compared to a temperature calculated by adding the temperature measured by the temperature sensor 120 to the temperature indicated by the dashed line 173. Thusly, the reduction of operation power may be delayed, as a further temperature reserve exists for this current operating parameter 182.

FIG. 6 furthermore shows a third model 177 for a relationship of temperature differences 171 over operating parameters 172. The third model 177 includes a regression of a relation of values of temperature differences and values of the operation parameter. The third model 177 particularly includes five line segments 183 with a uniform slope for each line segment 183 and therefore a more granular approach compared to the second model of FIG. 5. According to the current operating parameter 181, a corresponding temperature difference 182 may be selected, using the third model 177. As particularly this line segment 183 is similar to the corresponding line segment 183 of FIG. 5, there is no change in the corresponding temperature difference 182. However, for other operating parameters, the second model 176 and the third model 177 differ.

FIG. 7 furthermore shows a fourth model 178 for a relationship of temperature differences 171 over operating parameters 172. The fourth model 178 includes a regression of a relation of values of temperature differences and values of the operation parameter. The fourth model 178 particularly includes a logarithmic regression of the relation of values of temperature differences and values of the operation parameter. According to the current operating parameter 181, a corresponding temperature difference 182 may be selected, using the fourth model 178. The fourth model 178 may be easier to use in the operating method, as only one equation for the regression needs to be used for all possible values of the operation parameter.

FIG. 8 shows a flowchart 190 a method of manufacturing an optoelectronic component 100. In this method, the pixel array 110, the driving circuit 130 and the temperature sensor 120 are provided in a first step 191 in such a way that the temperature sensor 120 is in thermal contact with the pixel array 110. These may be arranged in a way that the optoelectronic component 100 of FIG. 1 is formed. In a second step 192 the model of the pixel array 110 is established, regarding a relationship between the operation parameter and the temperature difference. This model is then provided for the driving circuit 130 in a third method step 193, particularly by storing the model into the memory 132.

In one embodiment of the method of manufacturing the model is determined theoretically with the methods described above with respect to FIGS. 4 to 7. In one embodiment of the method of manufacturing the model is determined experimentally with the methods described above with respect to FIGS. 4 to 7.

Although the invention has been illustrated and described in detail by means of the preferred embodiment examples, the present invention is not restricted by the disclosed examples and other variations may be derived by the skilled person without exceeding the scope of protection of the invention.

### LIST OF REFERENCE SIGNS

100 optoelectronic component
110 pixel array
111 optoelectronic semiconductor emitter/chip
112 pixel
120 temperature sensor
130 driving circuit
131 central processing unit
132 memory
133 read-only memory
140 projection objective
141 projection lens
150 illumination device
151 light cone
160 flowchart
161 first step
162 second step
163 third step
164 fourth step
165 fifth step
166 sixth step
170 diagram
171 temperature difference
172 operation parameter
173 dashed line
174 cross
175 first model
176 second model
177 third model
178 fourth model
181 current operating parameter
182 corresponding temperature difference
183 line segment
190 flowchart
191 first step
192 second step
193 third step

1-19. (canceled)

20. A method of operating an optoelectronic component, wherein the optoelectronic component comprises a pixel array with a plurality of optoelectronic semiconductor emitters/chips, a temperature sensor, and a driving circuit, wherein the temperature sensor is in thermal contact with the pixel array, including the following steps:
Read-out of a temperature using the temperature sensor;
Determining an operation parameter of the pixel array, wherein the operation parameter includes an image to be displayed by the pixel array;
Estimating of a temperature difference between the temperature read-out from the temperature sensor and a junction temperature of a pn-junction of the pixel array based on the operation parameter and a model of the pixel array, wherein the temperature difference is different for at least two values of the operation parameter;
Adding the temperature of the temperature sensor to the temperature difference;
Comparing the sum of the temperature of the temperature sensor and the temperature difference to a maxi-mum junction temperature;
Reducing of the power of the pixel array when the sum of the temperature of the temperature sensor and the temperature difference exceeds the maximum junction temperature.

21. The method according to claim 20, wherein the model of the pixel array is stored in a memory of the driving circuit and may be read-out from that memory.

22. The method according to claim 20, wherein the operation parameter includes a current drawn by the pixel array.

23. The method according to claim 20, wherein the operation parameter includes a voltage supplied to the pixel array.

24. The method according to claim 20, wherein the operation parameter includes a power supplied to the pixel array.

25. The method according to claim 20, wherein a brightness value of pixels of the pixel array is added up and used as operation parameter.

26. The method according to claim 20, wherein the model includes a lookup table for a correlation between operation parameter and temperature difference.

27. The method according to claim 20, wherein the model includes a regression of a relation of values of temperature differences and values of the operation parameter.

28. The method according to claim 20, wherein the power of the pixel array is reduced by means of a pulse-width-modulation or a reduction of driving current and/or driving voltage of the pixel array.

29. An optoelectronic component comprising a pixel array with a plurality of optoelectronic semiconductor emitters/chips, a temperature sensor, and a driving circuit, wherein the temperature sensor is in thermal contact with the pixel array, wherein the driving circuit is equipped to execute the method according to claim 20.

30. The optoelectronic component according to claim 29, wherein the driving circuit comprises a memory, wherein the model is stored in the memory.

31. The optoelectronic component according to claim 30, wherein the memory is a read-only memory.

32. The optoelectronic component according to claim 29, further comprising a projection objective.

33. The optoelectronic component according to claim 29, wherein the driving circuit is equipped to read the model from an external memory, wherein the external memory is located in an external device.

34. An illumination device comprising an optoelectronic component according to claim 29.

35. A method of manufacturing an optoelectronic component according to claim 29, comprising the steps:
Providing the pixel array, the driving circuit and the temperature sensor, wherein the temperature sensor is in thermal contact with the pixel array;
Establishing the model of the pixel array regarding a relationship between the operation parameter and the temperature difference;
Providing the model for the driving circuit.

36. The method according to claim 35, wherein the model is determined theoretically.

37. The method according to claim 35, wherein the model is determined experimentally.
